(19) United States
(12) Patent Application Publication
(10) Pub. No.: US 2011/0062716 A1
(43) Pub. Date: Mar. 17, 2011

(54) ROTATION MAGNETIC BEARING WITH PERMANENT MAGNETS, PREFERABLY FOR A WIND TURBINE

(76) Inventors: Kristoffer Zeuthen, Vaerlose (DK); Steffen Zeuthen, Trondheim (NO); Siri Bergh, Trondheim (NO)

(21) Appl. No.: 12/449,317

(22) PCT Filed: Feb. 1, 2008
(86) PCT No.: PCT/DK2008/000046

§ 371 Date: Mar. 2, 2010

(30) Foreign Application Priority Data
Feb. 1, 2007 (DK) PA200700171

(51) Int. Cl. F03D 3/00; H02K 7/09; F03D 9/00

(52) U.S. Cl. 290/55; 310/90.5

(57) ABSTRACT

An apparatus (1) for rotational motion about a rotational axis (14) of a first member (2) relative to a second member (3), the first member having an outer surface being rotational symmetric about the rotational axis, and the second member having a corresponding rotational symmetric cavity with an inner surface accommodating at least part of the first member with an interspace between the outer surface of the first member and the inner surface of the second member. A repulsive magnetic field (4) between the first and the second member prevents contact between the outer surface of the first member and the inner surface of the second member. This magnetic field is achieved by a plurality of permanent dipole magnets (6, 13) arranged in the first member and in the second member with identical polarity (7) directed towards the interspace between the first and the second member. By using a plurality of magnetic dipoles an arbitrary shape can be provided with a surface having only north or south poles of magnets. The inventions is especially suited for rotational support of Darrieus-type wind turbines (20).

### FIELD OF THE INVENTION

The present invention relates to magnetic bearings. Especially, the invention relates to an apparatus for rotational motion about a rotational axis of a first member relative to a second member, the first member having an outer surface being rotational symmetric about the rotational axis, and the second member having a corresponding rotational symmetric cavity with an inner surface accommodating at least part of the first member with an interspace between the outer surface of the first member and the inner surface of the second member. A repulsive magnetic field between the first and the sec- and member prevents contact between the outer surface of the first member and the inner surface of the second member.

### BACKGROUND OF THE INVENTION

Magnetic bearings are known for a variety of application. One application is for trains, Magnetic Levitation Trains, where the train floats on a magnetic field that arises due to the permanent magnets in the bottom of the train and electromagnets in the railway track. Another application is for a spherical stepper motor for various sorts of robotics, for example as developed at the John Hopkins University in USA (published in IEEE/ASME Transactions on Mechatronics', Vol. 4/4, 1999) and on the Internet web site http://www.jhu.edu/˜news_info/news/home01/jan01/motor.html.

Other examples of magnetic bearings include a vibration damper with a spherical inner body suspended inside six active electromagnetic bearing elements, as disclosed in U.S. Pat. No. 4,947,067.

Further examples of magnetic bearings include solutions with solely permanent magnets, for example for bearings/journals for shafts in a piece of rotating machinery. But in those examples, the basic assumption is that the bearings are cylindrical, which limits the angular flexibility of the bearings, which is a severe disadvantage in case that the shaft receives a force component in a longitudinal direction.

It seems that there is a need for an industrial ‘heavy-duty’ solution where the journal/bearing is simple and robust.

### OBJECTIVE OF THE INVENTION

It is therefore an objective of the invention to provide a rotational magnetic bearing that is simple and robust with the option to create other than cylindrical shapes by simple means.

### DESCRIPTION OF THE INVENTION

This objective is achieved by a an apparatus for rotational motion about a rotational axis of a first member relative to a second member, the first member having an outer surface being rotational symmetric about the rotational axis, and the second member having a corresponding rotational symmetric cavity with an inner surface accommodating at least part of the first member with an interspace between the outer surface of the first member and the inner surface of the second member. The first member comprises a plurality of permanent dipole magnets arranged with identical polarity directed towards the interspace and that the second member comprises a plurality of permanent dipole magnets arranged with the same polarity towards the interspace opposing the magnetic field of the first member for repulsion of the first member from the inner surface of the cavity.

Between the first and the second member, a repulsive magnetic force is provided by oppositely directed magnetic fields. By accommodating the first member in the cavity of the second member such that the first member is surrounded by the second member in a cross section when viewing along the rotational axis, the repulsive force prevents the first member from contacting the second member within this cross section.

The versatility of the invention is primarily directed towards smoothly bending surfaces, for example an oval shape or most preferably a spherical shape. Possible shapes will be discussed more in detail below.

By using a plurality of dipole magnets, a magnetic field from only North or only South poles can by relatively easy means be provided on the entire outer surface of an arbitrarily shaped first member. For the invention, preferably, smoothly bending bodies of revolution are envisaged, for example smoothly bending shells of revolution, especially spherical shapes where a high number of rod magnets can be assembled radially to resemble a sphere, or spherical shell, with a field form only North or only South poles on its surface.

By providing dipole magnets for the magnetic field between the first and the second member, the system for creation of the magnetic field is maintenance-free, which is highly desirable for a number of applications, for example for apparatus at locations which are not easily accessible, including applications in connection with wind turbines located offshore, especially in deep sea.

In line with the above-mentioned smoothly bending surfaces, the direction of the magnetic fields from at least a number of the plurality of opposing dipoles of the first and of the second member have a directional component parallel with the rotational axis in order to repel the first member from the inner surface of the cavity in a direction parallel with the rotational axis. For example, if the rotational axis is vertical, those field lines that are repelling in the vertical direction can be used for supporting the weight of one member on the other. For example, if the second member is stationary, the repulsive inner surface of the cavity may be used to support the weight of the first member and, optionally, the weight of any additional means loaded on the first member.

As mentioned above, in a preferred solution, part of the outer surface of the first member has a shape being part of a sphere and part of the inner surface of the cavity has a shape being a corresponding part of a sphere—although with larger radius—for accommodating the spherical part of the first member in the spherical part of the cavity. Spherical solutions are relatively easily produced with magnetic dipoles in the form of magnetic rods arranged in a radial configuration. For example, all dipoles may be directed with their North poles towards the interspace between the inner surface of the second member and the outer surface of the first member.

The first member and the corresponding cavity need not resemble en entire sphere. In a further embodiment, for example, the first member is composed substantially of a first spherical part with a shape being part of a sphere and an axle extending from the spherical part along the rotational axis. In turn, the second member has a cavity with a shape being part of a sphere accommodating the spherical part of the first member. In addition, the second member has a collar in extension of the cavity, the collar accommodates the axle. In order to prevent the axle to contact the inner surface of the collar, the axle and the collar comprises a plurality of dipole magnets with identical polarity facing the interspace between the outer surface of the axle and the inner surface of the collar such that a repulsive force is created. This way, the bearing according to the invention is limited to mainly rotational movement about the rotational axis. However, a certain degree of tolerance is provided in the bearing for motion deviating from the rotational motion. Thus, over a minor extension within the tolerances, the bearing works as an omnidirectional hinge.

Though the spherical shape is the mostly preferred one due to its smooth rotation capabilities, deviations from a sphere are tolerable. Even other alternatives may function in dependence of the application and the necessary tolerances. For example, as an alternative to a sphere, other bodies of revolution with smoothly bending shapes may be used for the invention.

Some examples of these other smooth shapes may be defined in the way that the outer surface of the first member has a shape being part of a surface of revolution with a cross section resembling a Lamé curve and part of the inner surface of the cavity has a shape being a corresponding part of a corresponding surface of revolution resembling a Lamé curve, however, with a larger cross section for accommodating part of the first member inside the cavity. The Lamé curve is defined by (a/x)^{m}+(b/y)ⁿ=1 with x and y as variables and where a, b, m, and n are constants, and n>=2 and m>=2. For example, in the case of an ellipse, m=n=2, and for a spherical shape, m=n=2, and a=b. However, other example of smooth shapes are parabolic or hyperbolic bodies of revolution

In an example of such an embodiment, the first member is composed substantially of a body with an outer surface resembling a surface of revolution with such a smooth curve, for example a Lamé curve, as a cross section and an axle extending from the body along the rotational axis, wherein the second member has a corresponding cavity accommodating the body of the first member, and wherein the second member has a collar in extension of the cavity. As in the embodiment with the sphere, the collar accommodates the axle. Both the axle and the collar comprise a plurality of dipole magnets with identical polarity facing the interspace between the inner surface of the collar and the outer surface of the axle for repulsion of the axle from the inner surface of the collar.

In a further embodiment, the collar comprises an induction motor for electromagnetic driving of the axle. Alternatively, in addition or as part of the motor, the collar may comprise an electromagnetic power generator for generating electrical power from rotation of the axle relative to the collar. The latter is relevant in the case that the invention is used for supporting a wind turbine in extension of the axle from the first member.

In a preferred embodiment, the axle has a substantially vertical orientation, and the wind turbine is a Darrieus-type turbine with a plurality of airfoils fastened at their upper and lower ends to an extension of the axle. In the case that the wind turbine is mounted to the axle of the first member, the second member may comprise a vertical floating weight arrangement with cables for fastening of the second member to a sea bed. This floating weight arrangement is provided in the downward direction opposite to the axle of the first member.

In the foregoing, the turbine has been provided in extension of the axle of the first member, and the second member support the weight of the first member. However, the apparatus according to the invention may be used where the second member has a turbine fastened to it, and where the axle of the first member if fixed for supporting the weight of the turbine and the second member.

### DESCRIPTION OF THE DRAWING

The invention will be described in more detail with reference to the drawing, where

FIG. 1. illustrates a Z-ball bearing in a side view;

FIG. 2. illustrates parameters for a simple version of the Z-ball;

FIG. 3. shows the configuration of a ‘BuckySphere’ C720;

FIG. 4. shows prismatic magnetic construction elements for ball and bowl;

FIG. 5. illustrates a Single ‘Sink-Source’ Magnet and its Flux Lines;

FIG. 6. shows equipotential Lines for the field in FIG. 5;

FIG. 7. shows two magnets with adjacent north poles, N-N;

FIG. 8. shows two side-by-side placed magnets with N-S in the same direction with N pointing downwards;

FIG. 9. illustrates magnetic field lines in a Z-ball when the ball is in the centre of the bowl;

FIG. 10. illustrates magnetic field lines in a Z-ball when the ball is moved downwards relative to the bowl;

FIG. 11 illustrates a system with a Z-ball and a Darrieus wind turbine;

FIG. 12 shows FloWind examples;

FIG. 13 illustrates a z-ball bearing for a Darrieus wind turbine;

FIG. 14 is an illustrative example for interconnection between wind turbines in a deepwater offshore wind turbine park

### DETAILED DESCRIPTION OF THE INVENTION

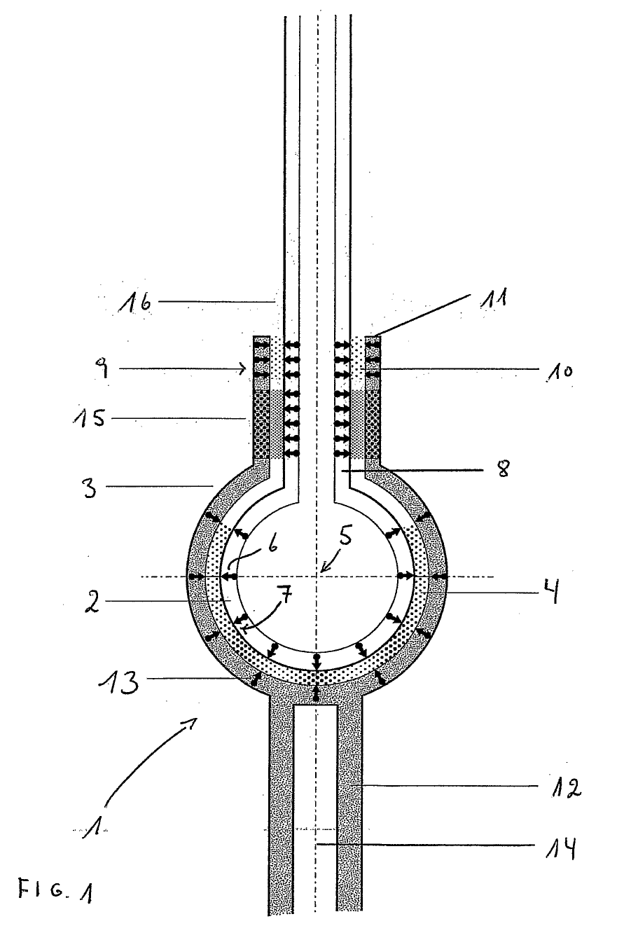

FIG. 1 illustrates an embodiment of the invention with a magnetic structure 1, in the following called Z-ball, wherein a magnetic ball-like structure 2, in the following called ball, is located inside an outer, spherical structure 3, in the following denoted bowl. The ball 2 as well as the bowl 3 comprises a permanent magnet 3 structure with a magnetic field 4 between the ball 2 and the bowl 3 having a repelling force between the ball 2 and the bowl 3. For example, a set of permanent magnets, shown as arrows 6, is located in the ball 2 with the north pole N —shown as the tip of an arrow 7 —directed away from the centre 5 of the ball 2. Another set of magnets 13 is located in the bowl 3 with the north pole N —also shown as the tip of an arrow—directed against the centre 5 of the bowl 3. This way, the ball 2 is suspended free-floating in a threedimensional magnetic field 4 and may rotate without any friction inside the bowl 4. This field is similar to an omni-directional hardening spring, where the characteristic increases when the distance between the ball and the bowl decreases.

The ball 2 is connected to a first column/rod 8 extending upward. The first column 8 is contained in a collar 11, where the collar 11 as well as the first column 8 at the height of the collar 11 is provided with a permanent magnetic structure 9, such that the collar is held within the magnetic field 11 between of the column 8 and the collar 11. This way, the Z-ball structure with the ball 2 in the bowl 3 approximately only rotates in a plane normal to the column 8.

The bowl 3, on the other hand, has a second column/rod 12 extending in the opposite direction relative to the first column 8 of the ball 2. Apart from minor movements of the first column 8 relative to the second column 12 due to mutual twisting and movement along the rotational axis 14, the first 8 and the second column 12 are co-linear and may rotate relatively to each other around a common axis 14.

It should be mentioned that the columns/rod 8,12 are only used for illustration and can be substituted by other structures. The column 8 can have en extension in the form of an axle 16 for mount of external devices to the column 8.

The bowl can be expanded with a collar 11 that contains coils 15 for induction. These coils 15 may be used as an induction motor for driving the ball 2 inside the bowl 3 or as a power generator for providing electricity in case that an outer force drives the ball 2 relative to the bowl 3. In addition, the induction motor may be used for braking the ball relative to the bowl 3. Such a braking mechanism may be combined with additional mechanical brakes.

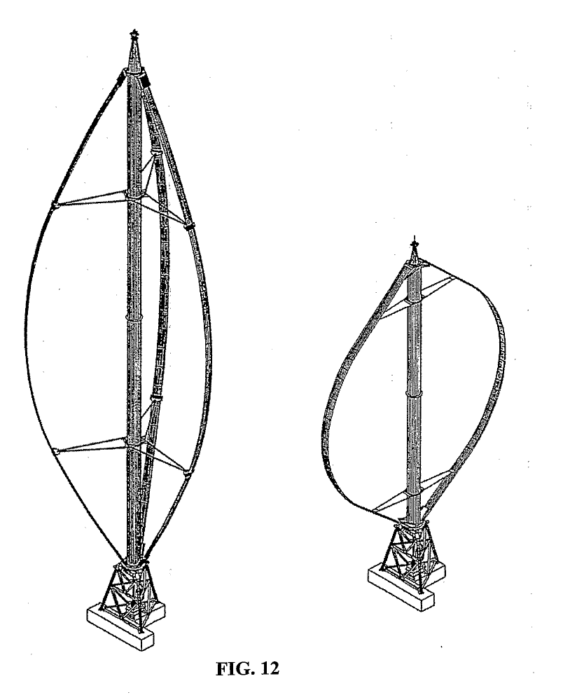

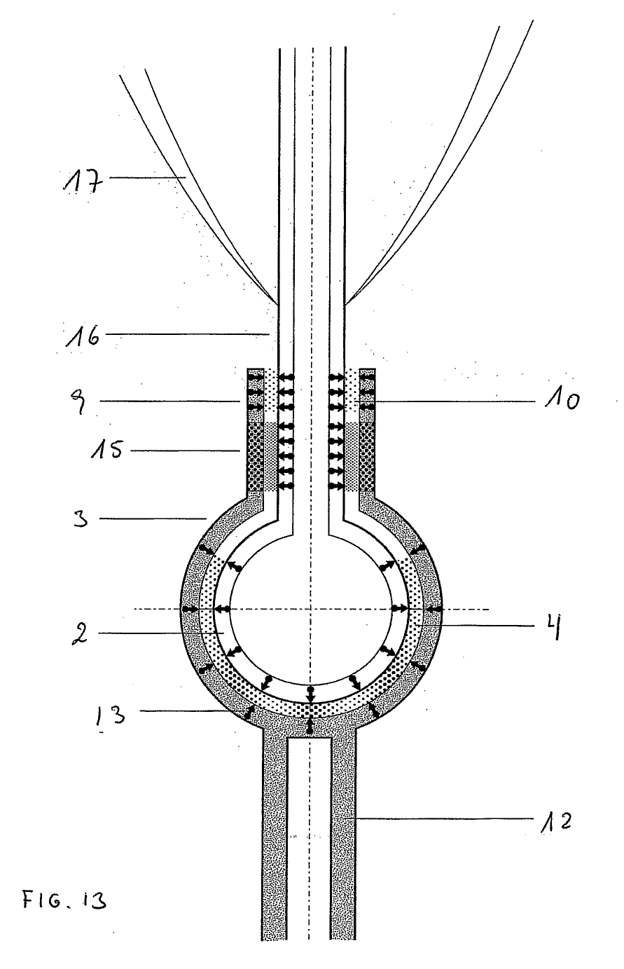

As it will appear in greater detail below, such a device is highly suited for wind turbine of the Darrieus type, for example as disclosed in U.S. Pat. No. 1,835,018 or as illustrated in FIG. 12. Such kind of wind turbines are more difficult to start than wind turbines of the more traditional propeller-type. Thus, electricity may be fed to the coils 15 for starting a rotation of the turbine, after which wind power continues the rotation of the turbine for producing electricity. For proper function, the rotational velocity may be kept within pre-set limits by using electronic control.

The advantage of using permanent magnets 6 for such a construction in contrast to electromagnets is fact that permanents magnets practically do not need maintenance and do not need electric feedback control mechanism. In many instances, for example, in connection with wind turbines a minimum of maintenance and control is desired.

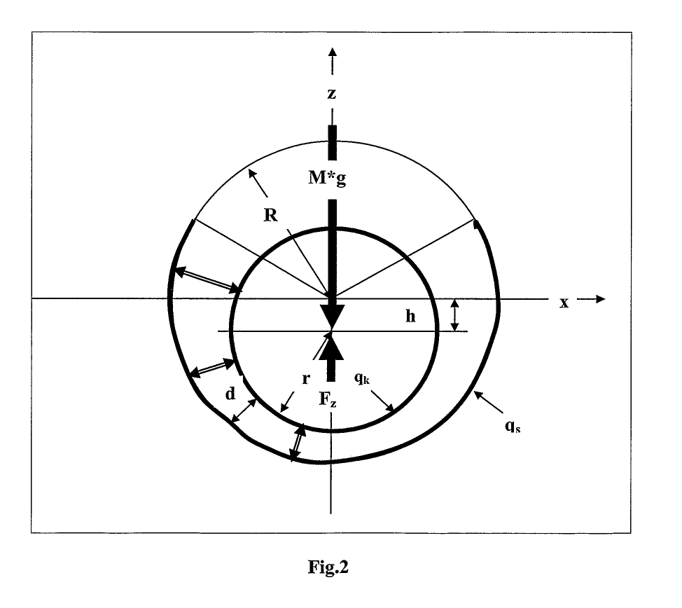

FIG. 2 illustrates different parameters of the Z-ball, where the ball has a radius r and the bowl has a radius R. When a force −F_{z}=M*g is imposed on the ball in the down-wards z-direction, where M is the mass of a load and g is the gravitational constant g=9.81 m/s², the ball is suspended in the magnetic field, when it is displaced a distance h from the centre, where the magnetic force—due to the smaller distance d between the ball and the bowl—has increased by F_{z} in order to balance the two opposite forces.

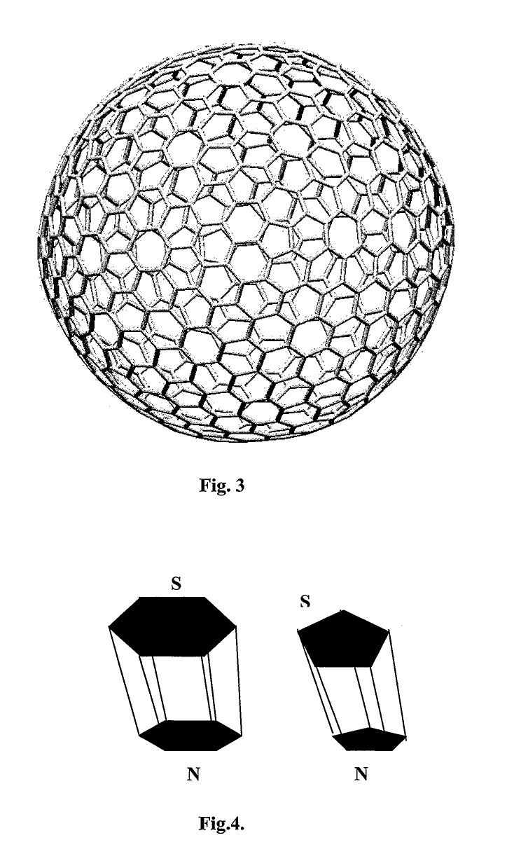

For the permanent magnets, different kinds of construction patterns are possible. Preferably, the pattern for the location of each set of magnets follows a geometrical formula for the most uniform distribution, as illustrated in FIG. 3 and in short called ‘Bucky Sphere’. Formally seen, the ‘BuckySpheres’ constitute a family of closed polyhedra. The branch of the family used here follows the formula: V=2*(H+10), where V is the number of vertices, and H is the number of hexagons. V=720 in FIG. 2. In this example, there are always exactly 12 pentagons in a complete ‘Bucky Sphere’ and 350 hexagons. These pentagons are located pair-wise on the 6 symmetry axes for one of the five ‘Platonic Solids’, namely the ‘Dodecahedron’. Thus the topology is completely fixed. In principle, the user/engineer determines H —but certain restrictions are in force if exclusively regular polygons are demanded where all side-lengths equal. Other Bucky Spheres may be used as models for the Z-ball.

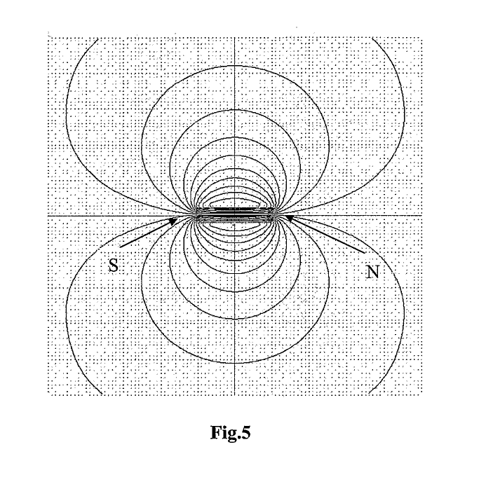

A preferred form of magnets is illustrated in FIG. 4. Such magnets can be assembled in large numbers to form a magnetic structure on the form of a spherical ball or bowl, respectively. FIG. 4 shows magnets where the top and bottom surfaces of the magnetic prism are either a hexagon or a pentagon in order to resemble the ‘Bucky Sphere” principle.

Advantages of the Z-ball according to the invention is that is constitutes a rotational coupling between two parts 2, 3, where the coupling is without friction between the two components eliminating abrasion and minimizing loss of energy. It can keep the rotational, friction-free coupling despite forces acting on the two components, where the forces are in other directions than along the rotational direction. When exposed to forces, the coupling acts resilient by pushing the ball 2 towards the bowl 3. It is possible to incorporate an induction device, for example in the form of a collar, as illustrated in FIG. 1. This device might be extremely useful for application in certain types of application, for example in connection with wind turbines as illustrated in FIG. 13, since the device could serve as gear and generator. That represents tremendous savings in weight, number of mechanical parts, and maintenance costs as compared to traditional solutions.

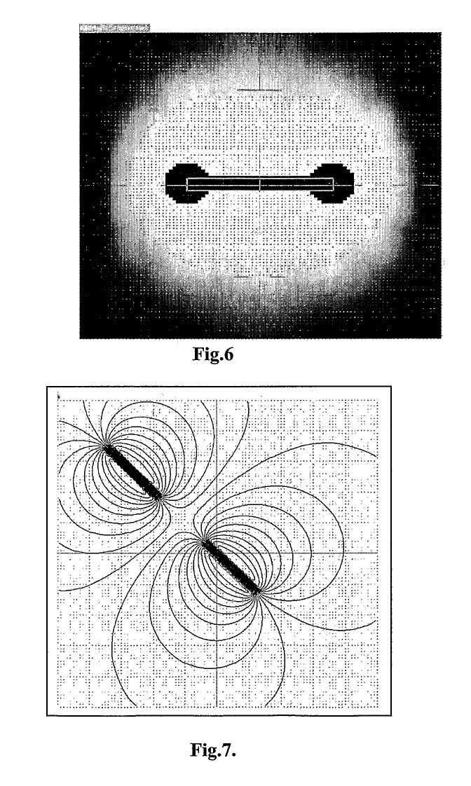

In the following, examples of field lines are illustrated in connection with the invention. As mentioned above, a large number of dipole magnets of the type as shown in FIG. 4 can be arranged to resemble the spherical magnetic structure. FIG. 5 illustrates such a dipole magnet with its flux lines. Each flux line (stream line) is closed and forms a loop. By convention, the direction of the flux is from the north pole N to the south pole S, where the flux lines do not cross. The equipotential lines are not indicated, but they are perpendicular to the flux lines. They can be seen (vaguely) on FIG. 6.

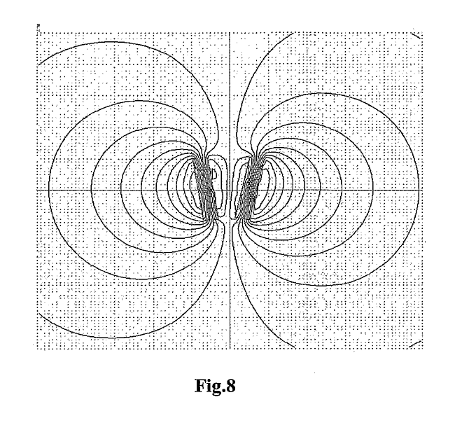

If two magnet rods are forced with their equal-polarity ends towards each other, a picture is obtained as in FIG. 7 with repelling field lines. In this case, the flux fields are compressed between the two magnets. FIG. 8 illustrates two magnets with N-S in the same direction.

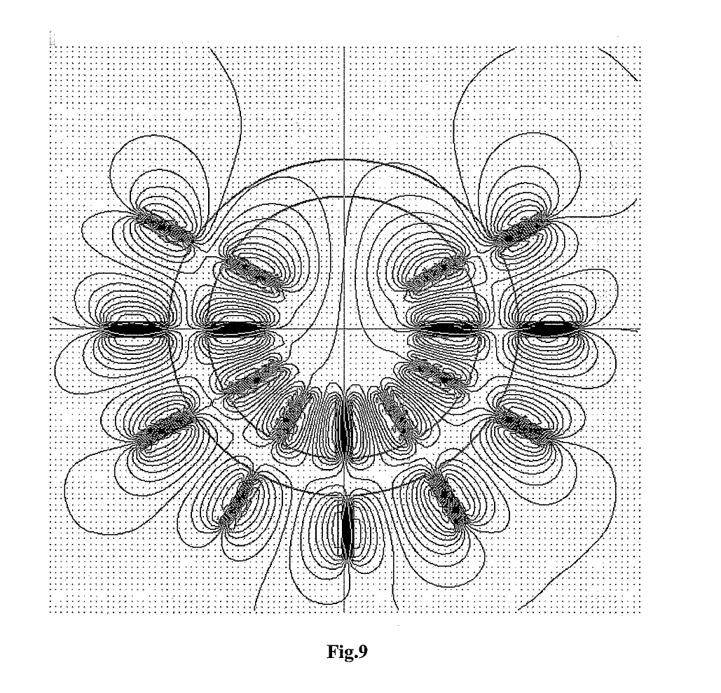

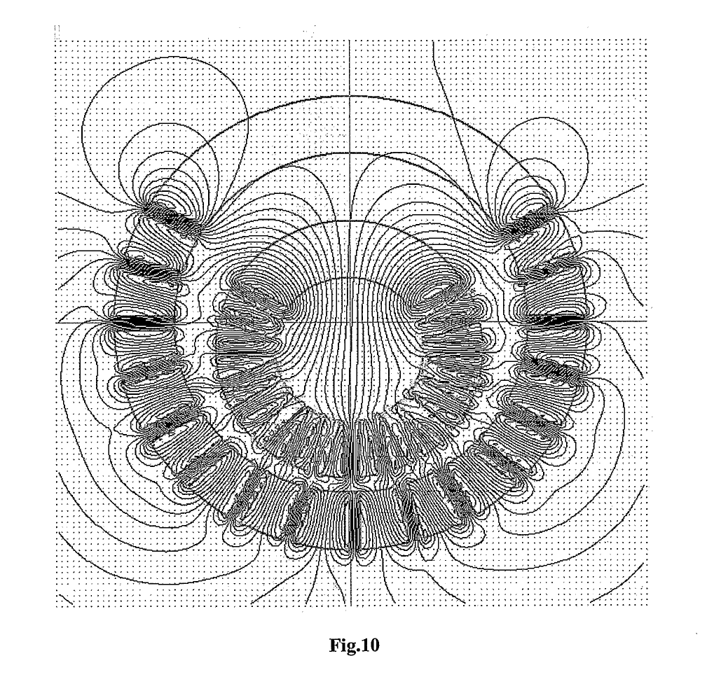

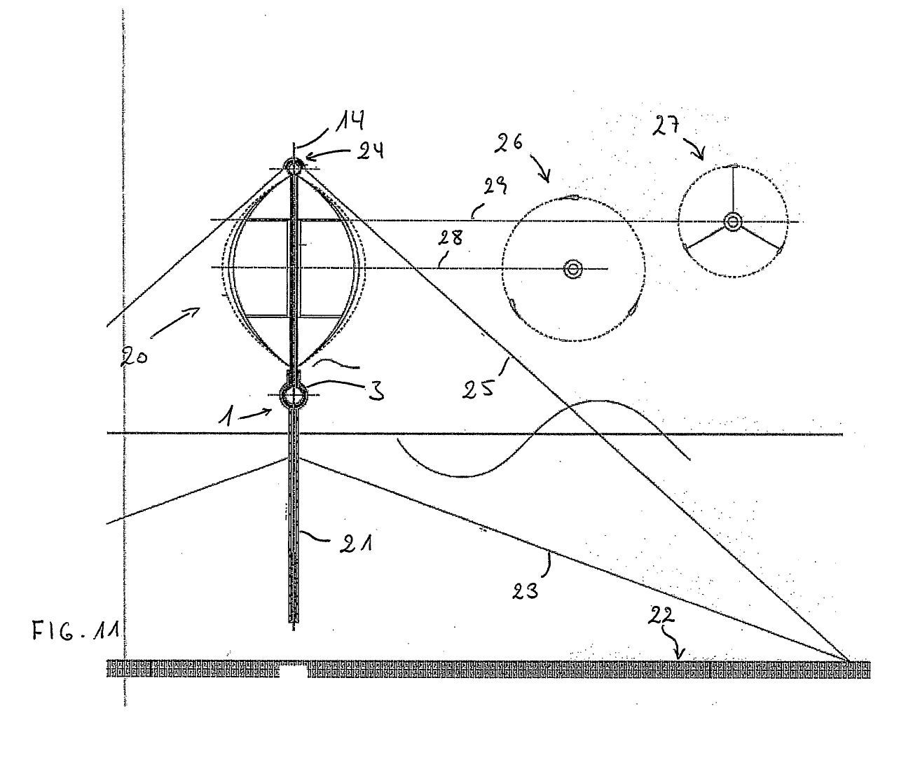

Based on this understanding, a magnetic assembly from a plurality of such dipole magnets can be constructed for the ball 2 and the bowl 3. Field lines for the magnetic field between the ball and the bowl are illustrated in FIG. 9 for a Z-ball when the ball 2 is in the centre of the bowl 3 and in FIG. 10 when the ball 2 is displaced towards the bowl 3.

It can be seen clearly how the flux field is compressed between the magnetic structures 2, 3. This creates pressure between two neighbouring magnets, but the energy/work needed for assembling the magnets is a production question; when all magnets are in place, they are frozen in a matrix to fill-in the gaps, and the matrix provides the necessary shell strength. Thus—from a membrane shell model point of view—the ball 2 and the bowl 3 are born with pre-tension. Preliminary calculations have shown that the resulting stresses should not be crucial if modern composite materials are used for the matrix.

The computer program used for creating FIG. 5-FIG. 10, J. S. Beeteson: ‘Visualising Magnetic Fields’, Academic Press, 2001, cannot apply the elements in FIG. 4. The magnetic fields, which are 3D fields, can only be modelled as 2D fields here. Thus FIG. 5-FIG. 10 must be seen as ‘2D-cuts’ only, and the magnets are simplified to bar magnets.

Conceptually, the field acts as a spring-mattress with radially directed springs, where the force increases when the distance between the ball 2 and the bowl 3 is reduced. The characteristic depends upon the type of alloy in the various magnets and the chosen modularity of the geometry. In theory, if the distance between the spherical surfaces goes towards zero, the force between the surfaces goes to infinite. It is not a theoretical constraint that the ball or the bowl should be ideal spherical surfaces or part of such perfect geometrical figures. Deviation from a perfect form is tolerable and often unavoidable, especially in the preferred case, where the magnetic structure is resembled from a plurality of dipole magnets.

According to Coulomb's Law then 2 permanent magnets with charges Q1 and Q2 and distance d exert a force F on each other:

F=[1/(4*π*ε0)]*Q1*Q2*(1/d²)
F: [Newton]=[N].
ε0: Permittivity in the material between the surfaces. [Farad/meter].

Here the material is air.
Q1 and Q2: [Coulomb]=[C]=[Amp*second].
d: [meter]=[m].

Here, we assume that the charges have the same sign—otherwise we get attraction instead of repulsion. The outer surface of the ball has a permanent magnetism qk [C/m²], and the inner surface of the bowl has a permanent magnetism of qs [C/m²]. The ball has its north pole N directed against the bowl, and the bowl has its North pole N directed against the ball: the ball ‘repulses’ the bowl and vice versa.

The magnetic field between the ball and the bowl is not a static field—it varies with time since the ball oscillates in the bowl. We do no get static equilibrium but dynamic equilibrium, which according to theory can be called stable.

It is impossible to provide a monopole magnetism on the spherical surfaces as assumed above. A realistic solution for a heavy-duty task must be based upon a discretization of the surfaces. In our invention, the ball and the bowl are both assemblies of permanent magnets of the types in FIG. 4. The basic pattern is given by FIG. 3 and comments. As known from geometry, as explained above, only combinations of such regular polygons can cover a sphere without leaving gaps. For a given application the user/engineer determines the number of hexagons (H) and the side-length in the regular polygons, see FIG. 4. The heights of the prisms in FIG. 4 are clearly identical to the thickness of the shells of revolution of the ball and bowl in FIG. 1.

### Application Area for Invention

The invention can be used for frictionless rotational coupling between different elements, for example the z-ball principle can be used as an axle bearing for rotational applications including drilling machines, engines and wheel bearing.

A preferred application is in connection with a wind turbine 20 of the Darrieus type with a vertical rotation axis 14, as illustrated in FIG. 11. The bowl 3 of the Z-ball 1 is connected to a vertical floating weight arrangement 21, typically denoted SPAR (Single Point Anchoring Repository). The SPAR 21 is fastened to the bottom 22 of the sea by a first set of wires 23. The ball of the Z-ball 1 is bearing a Darrieus wind turbine 20 which is loaded by a magnetic top arrangement 24 which also is fastened to the sea bed 22 by a second set of wires 25. The magnetic top arrangement 24 is similar to the Z-ball 1, although there is no strict need for a collar 11. In the right part of FIG. 11, cross-sectional views 26, 27 are shown with stipled reference lines 27, 28 for illustrating the position of the cross section.

FIG. 13 illustrates the Z-ball in an enlarged view in connection with the wind turbine and its airfoils 17 mounted to the extension 16 of the axle 8. FIG. 13 is in many aspects identical to FIG. 1, and the same notation is used.

Especially, the invention is suitable for a new type of deep-water offshore wind turbine for generation of electrical power. The term deep-water is preferably meant for a water-depth D>50 m. It should be stressed, however, that our invention is not limited to D>50 m—in principle it also works ‘near-shore’ and onshore, as the principle of the Z-ball is universal. However, the Z-ball is highly advantageous in the case of offshore turbines, if the turbine is part of a floating structure.

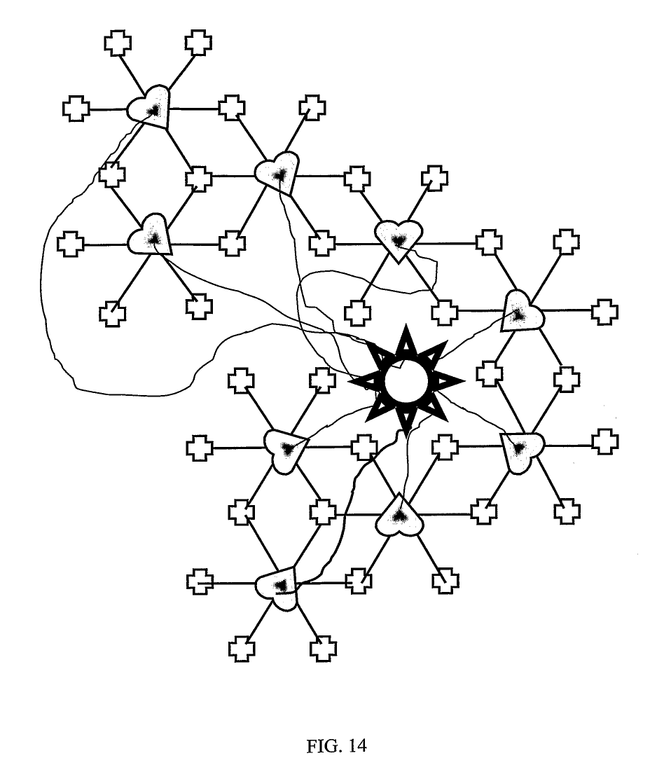

In one embodiment, the total construction of wind turbine 20, fastening wires 23, 25 and Z-ball 1 are designed to be a unit in an offshore wind turbine park, which is illustrated schematically in FIG. 14. For each unit having a heart-shape, at least three cables should be used for stabilization. However, for safety and stability reasons, in FIG. 14, there are used six cables with sea bed foundations at their ends, arranged in a hexagonal pattern.

For example, the sea bed foundation may be fixed seabed installations, suction anchors, or arrow anchors. There can be one anchoring point for two cables 23, 25 going to the SPAR 21 as well as to the spinning top 24, but according to the environment, including sea bed 22 conditions, wind, waves, and the resulting forces in the cables 23 25, it might be necessary to apply one group of anchoring points for the SPAR 21 and another group of anchoring points for the cables 23, 25 to the spinning top.

Onshore, these cables are installed with a high pre-tension to prevent collision with the airfoils 17, and to ensure that the natural frequencies of the cables do not interfere with the frequencies of the rotor (including the frequencies for the airfoils) under normal operational conditions. These considerations are naturally also valid offshore, and particularly—and more seriously—in view of the fact that the length of the cables is increased considerably. The upper limit for the water-depth D is thus determined by the necessary pre-tension and the existing technology for mooring/anchoring systems.

Our invention belongs to the group of ‘compliant offshore structures’. Since the Z-ball will oscillate due to the cable oscillations and the SPAR oscillations (due to wave excitation forces), then the ‘envelope’ for the whole structure can only be determined for a given environment: water-depth, wind & wave spectra, seabed, etc.

Two of the largest commercialized Darrieus-type turbines are shown in FIG. 12, the ‘FloWind 17 EHD’ and the ‘FloWind 19-meter’. They were produced and marketed primarily in USA and Canada in the period 1970-1997. They are belonging to the VAWT-family (Vertical Axis Wind Turbine). Other illustrations are given in U.S. Pat. No. 1,835,018 by Darrieus.

However, the invention is in no way depending upon these types with two or three airfoils. Other types with other number of airfoils have also been available on the market. We based our preliminary calculations on a 3-bladed rotor of the ‘FloWind 19-meter’ type in FIG. 14 with 3 airfoils instead of 2. The reason was that a 3-bladed rotor has better dynamic properties—more symmetry—than a 2-bladed rotor, and this is of paramount importance when we go offshore with a spinning top.

With reference to FIG. 13, preferably, the column 8, 16 rotates along with the airfoils 17. This seems to necessitate the use of struts between the column 8 and the airfoils 17. Variants of turbines without struts have been tried onshore, but seemingly without success, apparently due to serious problems with respect to the natural frequencies for the airfoils. The so-called natural modes are complicated for very long beams only supported at the end points.

The strength and production for polymeric materials have now advanced to a degree where polymer cables can be used offshore instead of the former heavy anchoring chains or steel ropes/wires. The light weight density of these advanced synthetic materials implies that they are virtually ‘weightless’ when submerged under water.

Especially, a Darrieus Wind Turbine with its characteristic vertical axis has 3 advantageous characteristic features:
it is omni-directionel—the turbine works if there is enough wind—the wind direction is without importance. This eliminates the need for a yaw mechanism, saving a tremendous amount of weight and cost.
the center of gravity is low—somewhere between the center of the rotor and the Z-ball, not near the nacelle as is the case for most members of wind turbines of the more traditional type with a horizontal rotation axis of the turbine.
it is fundamentally a lightweight structure. For example with reference to FIG. 14, the ‘FloWind 17 EHD’ (effect=0.3 MW) has a mass of 17.000 kg, and the ‘FloWind 19-meter’ (effect=0.24 MW) a mass of 10.000 kg. For the ‘The FloWinds’ the total mass of the airfoils is 4.300 kg and 2.000 kg, respectively. It is thus the (heavily loaded) column that is responsible for app. ⅔ of the mass of the turbine. In additionn, the load stems primarily from the tension in the cables and from the centrifugal forces from the airfoils. The column is a simply-supported Euler Column with eccentric loads from the struts, the struts being the carrying part of the centrifugal forces on the airfoils to the column. A reduction is weight can be achieved in addition by using cellular material for the column, which retains the necessary stability and stiffness, but which reduces the overall weight.

The following advantages are considered in connection with the wind turbine according to the invention.

1. The construction takes into account and minimizes the effect of bending moments
2. The Z-ball minimizes/eliminates the tear & wear and subsequent loss of power known from onshore Darrieus turbines. Thus the life-time is simply prolonged.
3. The induction device in the collar of the Z-ball acts as gear, generator, and control/brake; these components represent a substantial mass in a traditional turbine. This simplification, in connection with the elimination of the yaw mechanism, represents a considerable reduction in mass.
4. The number of mechanical components is reduced. That means simpler production methods, less mechanical components to transport and install, and fewer maintenance problems.
5. We estimate that our invention will have a ratio (MW/kg-installed-mass) which is 5 times higher than the ratio found in the various projects for deep-water offshore based installations with wind turbines having horizontal turbine axis.
6. If the chosen site for the wind turbine park should turn out to be a wrong choice due to different reasons, for example change of climate or politics, then the turbine, the Z-ball, and the SPAR can be split-up and moved independently with existing offshore vessels. This implies a high degree of mobility for the wind turbine park as such, and a high degree of freedom for the positioning of each unit in the park.
7. The invention can be adapted to almost any environment. Under the assumption that there are used two types of rotors, changes due to other parameters are diameter and length of the SPAR and cable lengths. The number of cables for the SPAR and for the top spinner should be at least six. Systems with three cables are possible in theory, but not to be recommended, as the redundancy of more cables implies a higher safety. The mooring/anchoring system will depend upon the site.
8. A short series of experiments has indicated that a Darrieus turbine is less sensitive to airfoil icing problems than most wind turbines with horizontal axis.

The Z-ball is the most preferred embodiment. However, other shapes, including slight deviations from a sphere, are also possible. Preferred solutions include rounded forms, for example, a shell/body of revolution with a cross section having an elliptical shape with the longest axis in the horizontal or vertical direction, respectively.

1-11. (canceled)

12. An apparatus (1) for rotational motion about a rotational axis (14) of a first member (2) relative to a second member (3), the first member (2) having an outer surface being rotational symmetric about the rotational axis, and the second member having a corresponding rotational symmetric cavity with an inner surface accommodating at least part of the first member with an interspace between the outer surface of the first member and the inner surface of the second member, wherein a repulsive magnetic field (4) between the first and the second member prevents contact between the outer surface of the first member and the inner surface of the second member, wherein the first member comprises a plurality of permanent dipole magnets (6) arranged with identical polarity (7) directed towards the interspace and that the second member comprises a plurality of permanent dipole magnets (13) arranged with the same polarity towards the interspace opposing the magnetic field of the first member for repulsion of the first member from the inner surface of the cavity.

13. An apparatus according to claim 12, wherein the direction of the magnetic fields from at least a number of the plurality of opposing dipoles (6, 13) of the first (2) and of the second (3) member have a directional component parallel with the rotational axis (14) for repulsion of the first member from the inner surface of the cavity in a direction parallel with the rotational axis.

14. An apparatus according to claim 13, wherein part of the outer surface of the first member (2) has a shape being part of a surface of revolution with a smoothly curving cross section, and wherein part of the inner surface of the cavity has a shape being a corresponding part of a corresponding surface of revolution with a larger cross section for accommodating part of the first member inside the cavity.

15. An apparatus according to claim 14, wherein the first member (2) substantially is composed of a body with an outer surface resembling a surface of revolution with smoothly curving cross section and an axle (8) extending from the body along the rotational axis (14), wherein the second member (3) has a corresponding cavity accommodating the body of the first member, and wherein the second member has a collar (11) in extension of the cavity, the collar accommodating the axle, wherein the axle comprises a plurality of dipole magnets (6) with identical polarity facing the inner surface of the collar, and wherein the collar comprises a plurality of dipole magnets (13) with the same polarity facing the outer surface of the axle, for repulsion of the axle from the inner surface of the collar.

16. An apparatus according to claim 15, wherein the collar in addition comprises induction coils (15) for electromagnetic driving of the axle (8), for electromagnetic braking of the axle, for generation of electricity or for a combination of these.

17. An apparatus according to claim 15, wherein the apparatus comprises a wind turbine (20) supported by the combination of the first and the second member.

18. An apparatus according to claim 17, comprising a wind turbine (20) in extension of the axle.

19. An apparatus according to claim 17, comprising a wind turbine fastened to the second member and an axle of the first member is fixed for supporting the weight of the turbine and the second member.

20. An apparatus according to claim 14, wherein part of the outer surface of the first member has (2) a shape being part of a sphere and wherein part of the inner surface of the cavity has a shape being a corresponding part of sphere for accommodating the spherical part of the first member in the spherical part of the cavity.

21. An apparatus according to claim 20, wherein the magnetic dipoles (6, 13) are magnetic rods arranged in a radial configuration.

22. An apparatus according to claim 18, wherein the axle (8) has a substantially vertical orientation, and the wind turbine (20) is a Darrieus-type turbine with a plurality of airfoils (17) fastened at their upper and lower ends to an extension (16) of the axle.

23. An apparatus according to claim 22, wherein the second member (3) in the downward direction opposite to the axle (8) comprises a vertical floating weight arrangement (12, 21) with cables (23) for fastening of the second member to a sea bed (22).
